(19) United States
(12) Patent Application Publication
(10) Pub. No.: US 2024/0139652 A1
(43) Pub. Date: May 2, 2024

(54) Solids Removal System and Method

(71) Applicant: Kyle Dylan Nap, Irving, TX (US)

(72) Inventor: Kyle Dylan Nap, Irving, TX (US)

(21) Appl. No.: 18/496,204

(22) Filed: Oct. 27, 2023

Related U.S. Application Data
(60) Provisional application No. 63/420,259, filed on Oct. 28, 2022.

(51) Int. Cl. B01D 21/00; B01D 21/24; B01D 21/34; C02F 1/00; C02F 1/24

(52) U.S. Cl. CPC B01D 21/0084; B01D 21/2433; B01D 21/245; B01D 21/34; C02F 1/008; C02F 1/24; C02F 2103/10; C02F 2201/005

(57) ABSTRACT

A system for solids removal is provided that includes a vessel having an upper end, a lower end opposite the upper end, an outer wall defining an interior space of the vessel and extending from the lower end to the upper end. The vessel further includes a bottom connected to the outer wall adjacent the lower end. The vessel includes an underflow weir, a solids collection weir, and a weir bottom connected to the underflow weir and the solids collection weir. The vessel further includes an overflow weir positioned in the interior space and connected to the vessel adjacent the lower end of the vessel and extending a distance to an upper end of the overflow weir located adjacent the upper end of the vessel, the overflow weir located between the underflow weir and the outlet.

### CROSS-REFERENCE TO RELATED APPLICATIONS

This application claims the benefit of U.S. Provisional Application No. 63/420,259 filed Oct. 28, 2022, which is incorporated by reference herein as if reproduced in its entirety.

### BACKGROUND

It may be useful to remove solids from a solid-liquid mixture. Examples of solid-liquid mixtures include waste water produced as a byproduct of oil and gas exploration or production, such as drilling mud, fluid produced as a byproduct of completion or fracking, production byproducts such as salt water, or other waste solid-liquid mixtures such as sewage, mining waste, feed water, or other mixtures. Various means for separating and treatment of contaminated waste water have been proposed.

### SUMMARY

In one embodiment, a solids removal system is disclosed that includes a vessel having an upper end, a lower end opposite the upper end, an outer wall defining an interior space of the vessel and extending from the lower end to the upper end. The vessel further includes a bottom connected to the outer wall adjacent the lower end, a bottom drain connected to the bottom, an inlet coupled to the outer wall adjacent the lower end, and an outlet coupled to the outer wall adjacent the lower end. The vessel includes an underflow weir positioned in the interior space and connected to the vessel near the upper end of the vessel and extending a distance to a lower end of the underflow weir located adjacent the lower end of the vessel, the underflow weir located between the inlet and outlet. The vessel includes a solids collection weir positioned in the interior space between the underflow weir and the inlet, the solids collection weir having an upper end and a lower end, the upper end of the solids collection weir located a distance from the upper end of the vessel, and the lower end located adjacent the lower end of the vessel. The vessel includes a weir bottom having a first side and a second side, the weir bottom connected on the first side to the underflow weir and connected on the second side to the solids collection weir. The vessel further includes an overflow weir positioned in the interior space and connected to the vessel adjacent the lower end of the vessel and extending a distance to an upper end of the overflow weir located adjacent the upper end of the vessel, the overflow weir located between the underflow weir and the outlet.

In another embodiment, the present disclosure provides a method for solids removal, including providing a vessel having a first channel, a second channel, and a third channel, the first channel between a first side of the vessel and a solids collection weir, the second channel between an underflow weir and an overflow weir, the third channel between the overflow weir and a second side of the vessel. The method includes providing contaminated fluid to the first channel of the vessel, via an inlet of the vessel, and sensing a level of the fluid in the first channel of the vessel. The method includes controlling a volume of the fluid provided to first channel of the vessel to increase the level of the fluid in the first channel to an overflow level of the fluid, the overflow level associated with a height of the solids collection weir, wherein controlling the volume of the fluid further comprises flowing the fluid from the first channel to the second channel via the underflow weir and flowing the fluid from the second channel to the third channel via the overflow weir. The method includes collecting first solids from the fluid overflowing the solids collection weir in a solids collection channel defined by at least a portion of the solids collection weir, collecting second solids from the fluid settling adjacent a bottom of the vessel adjacent a lower end of the underflow weir, and collecting third solids from the fluid settling adjacent the bottom of the vessel between the overflow weir and the second side of the vessel. The method further includes removing treated water from the third channel via an outlet provided adjacent the second side of the vessel.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is an illustration of a solids removal system and a side cut-away view of a vessel thereof according to one embodiment of the present disclosure.

FIG. 2 is partial cross-sectional view of the vessel of the solids removal system taken along line 2-2 of FIG. 1 according to one embodiment of the present disclosure.

FIG. 3 is an illustration of another embodiment of the solids removal system employing multiple vessels connected in parallel according to one embodiment of the present disclosure.

FIG. 4 is a flow chart of a method for solids removal according to one embodiment of the present disclosure.

FIG. 5 is a diagram of one embodiment of a computer system capable of implementing the systems and methods described herein.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

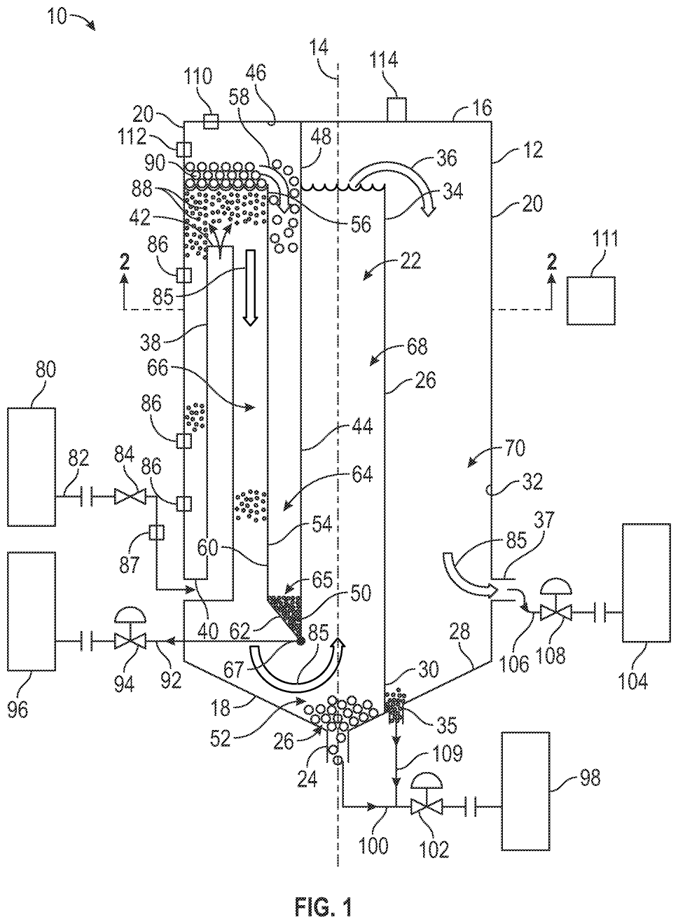

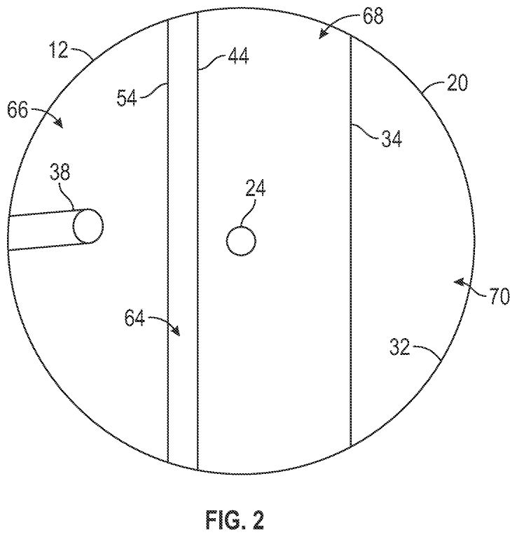

FIGS. 1 and 2 illustrate an embodiment of a solids removal system 10. In this embodiment, the solids removal system 10 includes a vessel 12 that is oriented vertically along longitudinal axis 14. The vessel 12 has an upper end 16 and a lower end 18. In this embodiment, the vessel 12 may be configured substantially cylindrically having an outer wall 20 extending from the lower end 18 to the upper end 16 and defining an interior space 22. While the vessel 12 is described as generally cylindrically shaped, it is anticipated that the vessel 12 may be oval, elliptical, rectangular, or otherwise configured in other embodiments. The upper end 16 may be flat or may slope near the outer wall 20 to prevent moisture from collecting on the upper end 16 of the vessel 12. The lower end 18 may be conically shaped and slant downward toward a bottom drain 24 that is generally centered about the lower end 18 to form a first discharge area 25, which will be described in further detail below.

The vessel 12 includes an overflow weir 26 provided in the interior space 22 of the vessel 12. The overflow weir 26 may be configured as a plate mounted to an interior bottom 28 of the vessel 12 at a lower end 30 of the overflow weir 26 and extending across the interior space 22 between an inside 32 of the outer wall 20 and provide a fluid barrier dividing a portion of the interior space 22 of the vessel 12. The upper end 34 of the overflow weir 26 may extend near the upper end 16 of the vessel 12 defining a treated or clean water spillway 36. In some embodiments, the upper end 34 of the overflow weir 26 may be from a few inches to two or more feet below from the upper end 16 of the vessel 12, or in other embodiments the upper end 34 of the overflow weir 26 may be about twelve inches below the upper end 16 of the vessel 12. In this embodiment, a drain port 35 is provided near the lower end 30 of the overflow weir 26. An outlet 37 is also positioned near the lower end 18 of the vessel 12 adjacent the overflow weir 26.

The vessel 12 further includes an inlet pipe 38 connected to an inlet 40 for receiving solid-laden liquids, contaminated, or other fluids. The inlet 40 is positioned between the upper and lower ends 16, 18 of the vessel 12. The location or height from the lower end 18 of the vessel 12 of the inlet 40 and the outlet 37 may be related. For example, in some embodiments, it may be desirable to locate the inlet and outlet 40 and 37 at about the same height from the lower end 18 of the vessel 12, while in other embodiments the location of the inlet 40 relative to the lower end 18 of the vessel 12 may be lower than that of the outlet 37. Other locations and positions of the inlet 40 and outlet 37 are anticipated and will readily suggest themselves to one skilled in the art in light of the present disclosure.

The inlet pipe 38 initially extends horizontally, relative to the vertical operational orientation of the vessel 12, from the inlet 40 a distance into interior space 22 of the vessel 12. The inlet pipe 38 elbows to extend vertically, again relative to the vertical operational orientation of the vessel 12, towards the upper end 16 within the interior space 22 of the vessel 12. The inlet pipe 38 is open at an outlet end 42 to allow solids-laden liquids or other fluids to enter the interior space 22 of the vessel 12 near the upper end 16 of the vessel 12.

The vessel 12 is further provided with an underflow weir 44 that is provided in the interior space 22 of the vessel 12. The underflow weir 44 may be configured as a plate mounted to an interior top 46 of the vessel 12 at an upper end 48 of the underflow weir 44 and extending across the interior space 22 between the inside 32 of the outer wall 20 and provide a further fluid barrier dividing a portion of the interior space 22 of the vessel 12. A lower end 50 of the underflow weir 44 may extend near the lower end 18 of the vessel 12 defining an underflow opening 52, which is further described below. In some embodiments, the lower end 50 of the underflow weir 44 may extend to about one to about three feet from the lower end 18 of the vessel 12, while in still other embodiments the lower end 50 of the underflow weir 44 may extend to about two feet from the lower end 18 of the vessel 12.

The vessel 12 also includes a solids-collection weir 54 that is provided in the interior space 22 of the vessel 12. The solids-collection weir 54 may be configured as a vertically oriented plate that extends across the interior space 22 of the vessel 12 parallel and adjacent the underflow weir 44. The solids-collection weir 54 is mounted to extend across the interior space 22 between the inside 32 of the outer wall 20 of the vessel 12. An upper end 56 of the solids-collection weir 54 may extend near the upper end 16 of the vessel 12 providing a solids spillway 58, which will be discussed in greater detail below. Similar to the overflow weir 26, in some embodiments, the upper end 56 of the solids-collection weir 54 may be from a few inches to two or more feet below the upper end 16 of the vessel 12, or in other embodiments the upper end 56 of the solids-collection weir 54 may about twelve inches below the upper end 16 of the vessel 12.

A lower end 60 of the solids-collection weir 54 is connected to a slant plate 62. The slant plate 62 is further connected to the lower end 50 of the underflow weir 44 and forms a solids collection channel 64 defined by the solids-collection weir 54 and the underflow weir 44 on the sides and the slate plate 62 on the bottom. While the present embodiment illustrates the slate plate 62 connected at or near the lower end 50 of the underflow weir 44, in other embodiments, the solids-collection weir 54 may not extend as close the to the lower end 18 of the vessel 12 as currently illustrated, but instead may extend less far and, in such embodiments, the slant plate 62 may be connected to the underflow weir 44 anywhere and not necessarily at or near the lower end 50 of the underflow weir 44. In still other embodiments, not shown, the present disclosure anticipates other configurations of the solids collection channel 64 in lieu of the slate plate 62, such as V-shaped or other configurations that provide a lowest collection point for collection and removal of solids from the solids-collection weir 54. Regardless of the configuration, the solids collection channel 64 is configured to collect the solids 90 that overflow the solids spillway 58 at a discharge area 65 located near the lower end 50 of the underflow weir 44, as will be further described below.

As can be seen, the interior space 22 is divided into generally three channels, an inlet channel 66, a transverse channel 68, and an outlet channel 70. The inlet channel 66 is defined within the interior space 22 as the space between the portion of the outer wall 20 adjacent the inlet 40 and the solids collection weir 54 and underflow weir 44. Thus, the inlet pipe 38 can be said to be substantially situated or suspended in the inlet channel 66. The transverse channel 68 is defined within the interior space 22 as the space between the underflow weir 44, overflow weir 26, and outer wall 20. The outlet channel 70, which may also be referred to as the clear well, is defined within the interior space 22 as the space between the overflow weir 26 and the outer wall 20 adjacent the outlet 37. Accordingly, the solids-collection weir 54, the underflow weir 44, and overflow weir 26, may be said to divide the relative internal volume of the vessel 12 into three compartments, that is, the inlet channel 66, the transverse channel 68, and the outlet channel 70. The relative volume of each compartment may about the same in some embodiments, while in other embodiments the inlet channel 66 and the transverse channel 68 occupy about 40 percent of the total volume each, while the outlet channel 70 occupies about 20 percent of the internal volume of the vessel 12. One skilled in the art will appreciate, based on the present disclosure that the locations and division of the interior volume of the vessel 12 may be based on various considerations, including the desired speed at which fluid passes through the various channels and other considerations to promote solids to settle or fall-out of the fluid for collection and removal.

In some embodiments, the vessel 12 may be about 20-55 feet in height measured from the upper end 16 to the lower end 18, while in preferred embodiments the vessel 12 may be 25-45 feet in height, or more preferably between 30-40 feet in height. The vessel 12 may further be approximately 6-12 feet in wide, and more preferably between 8-10 feet in width. The vessel 12 may, in some embodiments, be sized to such that the liquid capacity of the vessel 12 is between 500-1,000 barrels.

A contaminated liquid source 80 may contain solid-liquid mixtures as discussed above, which may include waste water produced as a byproduct of oil and gas exploration or production, such as drilling mud, fluid produced as a byproduct of completion or fracking, production byproducts such as salt water, or other waste solid-liquid mixtures such as sewage, mining waste, feed water, or other mixtures, all of which may be referred to as solids-laden liquids, contaminated liquids, or merely liquids. The solid-liquid mixture is conveyed to inlet 40, via inlet line 82 and inlet valve 84 using a pump 87. Although only one pump 87 is shown, other pumps may be present at various locations as desired as will suggest themselves to a skilled artisan. The pump 87 may be any type of pump configured to move the solid-liquid mixture, such as centrifugal, rotary valve, gear pump, and so on. The liquid-solid mixture passes through inlet 40 into the inlet pipe 38 and exits the outlet end 42 into the interior space 22, and more specifically the inlet channel 66. The general flow of the liquid-solid mixture and clean or treated water through the vessel 12 is depicted by arrows 85.

Bubblers 86 may inject an air or an air-water mixture under pressure to generate bubbles 88 in the liquid-solid mixture to promote flotation of lighter solids in the liquid-solid mixture in inlet channel 66. The bubbles 88 float the lighter solids, colloidals, along with other low gravity solids upward and over the solids spillway 58 and into the solids collection channel 64. The lighter solids will then collect in the second discharge area 65. A second drain port 67 is connected adjacent the second discharge area 65. A first removal line 92 is connected to the second drain port 67 and conveys the lighter solids or sludge, via a first pneumatic valve 94, for storage in a first removal tank 96. While the first pneumatic valve 94 is shown, other valves and pumps may be used in other embodiments. Meanwhile, heavier solids in the liquid-solid mixture in inlet channel 66 may tend to gravitate downward and collect in the first discharge area 25 near the bottom drain 24. Heavier solids that collect in the first discharge area 25 are evacuated though the bottom drain 24 to a second removal tank 98, via second removal line 100, and a second pneumatic valve 102. While the second pneumatic valve 102 is shown, other valves and pumps may be used in other embodiments.

The liquid-solid mixture generally travels downward inlet channel 66 and passes underneath the lower end 50 of underflow weir 44 and then travels upward in the traverse channel 68 and flows over the clean water spillway 36 into the outlet channel 70. The terms treated, raw treated, or clean water are terms which may be used interchangeably for purposes of this disclosure. Remaining solids may collect at the bottom of outlet channel 70 and be removed, via drain port 35, while the remaining treated or clean water or fluids exit via outlet 37. Drain port 35 may be positioned near the lower end 18 of the vessel 12, or more preferably in some embodiments at the lowest point, of the lower end 18 of the vessel 12 in the outlet channel 70 to promote collection of solids before the treated fluids exit the vessel 12, via outlet 37. Solids evacuated via drain port 35 may be communicated, via a third removal line 109, to the second removal tank 98 or elsewhere as desired.

The treated or clean water then exits outlet channel 70 to a clear or clean water tank 104 via outlet line 106 and outlet valve 108. While outlet valve 108 is illustrated as a pneumatic valve, other valve types and pumps may be used in other embodiments.

The vessel 12 may also include a level sensor 110 located adjacent the upper end 16 of the vessel 12. Level sensor 110 may be a density sensor or any one or more sensors configured to measure the level, depth, solids, density, and so on of the fluid in the vessel 12. Level sensor 110 may be in communication with and monitored by various computer and/or control systems 111, such as but not limited to computer or other systems described in further detail below, to maintain the fluid level and other systems for operation of the solids removal system 10. For example, such control system 111 may monitor the level sensor 110 and further be communicatively coupled to actuate valves, such as the inlet valve 84, first and second pneumatic valves 94, 102, outlet valve 108, and one or more pumps 87. Thus, based on the fluid level sensed by level sensor 110 in the inlet channel 66, the control system 111 may actuate the valves, such as the first pneumatic valve 94 to remove solids and sludge and/or inlet and outlet valves 84 and 108 to raise and lower the fluid level in the vessel 12 as necessary to maintain the fluid level in the vessel 12, such as the fluid level in the inlet channel 66, at the appropriate levels to promote treatment of the fluids.

The vessel 12 may further include an emergency overflow sensor 112 located in various positions, such as in the inside 32 of the outer wall 20 (as shown) near the upper end 16 of the vessel 12 or otherwise located. The emergency overflow sensor 112 may be any sensor configured to measure and/or monitor the fluid levels in the vessel 12. The emergency overflow sensor 112 may be similarly in communication with the control system 111 so as to and actuate various valves to control fluid levels in the vessel 12 when the emergency overflow sensor 112 detects a particular fluid level. For example, when overflow sensor 112 senses fluid levels about desired or threshold levels, the control system 111 may shut down one or more pumps 87 and close one or more valves, such as inlet valve 84, providing contaminated liquids or fluid to the vessel 12.

The vessel 12 may further include a vent 114 located on the upper end 16 of the vessel 12. The vent 114 may operate to relieve fluid, air, gas, that accumulates in the vessel 12. In some embodiments, the vent 114 may be configured with a scrubber to filter fluids and gasses exiting the vessel 12.

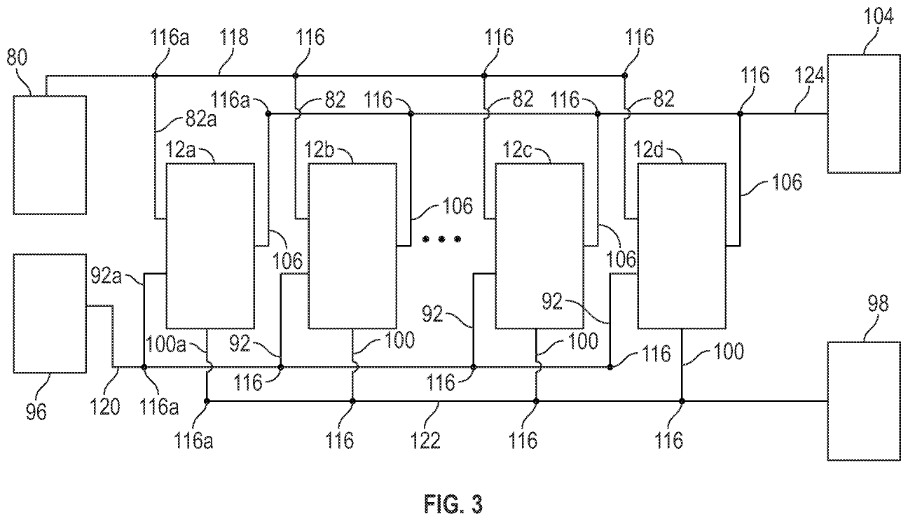

FIG. 3 illustrates another embodiment of the solids removal system 10 employing multiple vessels 12 connected in parallel. Each of the vessels 12 may be similar in configuration and operation to the vessel 12 described above with regard to FIGS. 1 and 2. While the present embodiment illustrates a configuration employing four (4) vessels 12a-12d, any number of vessels 12, source and removal tanks, and so on may be used and are within the spirit and scope of the present disclosure. Vessel 12a includes inlet line 82a for receiving the solid-liquid mixtures from contaminated liquid source 80. In this embodiment, however, the inlet line 82a receives the solids-liquid mixture from the contaminated liquid source 80 via inlet feeder line 118 and valve 116a. Valve 116a may be a three-way or other type of valve or attachment configuration to allow the solids-liquid mixture to be conveyed to vessel 12a or, alternatively, to shut-off the flow of the solids-liquid mixture to vessel 12a while still providing the solids-liquid mixture downstream of the vessel 12a to other connected systems, such as vessels 12b-d.

Vessel 12a further includes the first and second removal lines 92a and 100a connected for removal of solids and waste to the first and second removal tanks 96 and 98, respectively. Although not shown in this illustration, other inlet and outlet lines described above may be present, such the third removal line 109. The first and second removal lines 92a and 100a are similarly connected to the first and second removal tanks 96 and 98, via first and second removal feeder lines 120 and 122, respectively, and valves, such as valve 116a described above. Vessel 12a further includes outlet line 106a for removal of clean or treated water to the clean water tank 104. Again, outlet line 106a is connected to the clean water tank 104 via outlet feeder line 124 and a valve, such as valve 116a described above. The remaining vessels 12b-d are similarly configured and will not be described for purposes of brevity.

As can be seen, the embodiment illustrated in FIG. 3 allows for parallel operation of numerous vessels 12, as well as, the ability to isolate any of the individual vessels 12 for cleaning and repair while enabling the continued operation of the remaining, non-isolated, vessels 12. The vessel 12 configured according to the present disclosure may be enabled for treatment of from 2-20 barrels of fluid per minute or more, or more preferably between 4-12 barrels per minute, and thus enabled for treatment of from 10,000-30,000 barrels per day. Accordingly, numerous vessels 12 configured as disclosed in this embodiment may have the capacity to treat tens of thousands to hundreds of thousands or more barrels per day of waste water.

The vessel 12 and associated components disclosed herein may be constructed of various materials such as steel, coated carbon steel, or any other suitable materials. While not limited to any particular configuration, as discussed above with regard to the physical dimensions of the vessel 12, the height of the vessel 12 may be greater than the width of the vessel 12 in some embodiments. Such greater height vs. width design of the vessel 12 may be useful and provide additional time during processing for separation and settling of solids. Specifically, the greater height provides additional time for the solids 90 to float for removal, such as via solids spillway 58, and settling of solids near the lower end 18 of the vessel 12 for removal, for example via the bottom drain 24. Further, it will be appreciated that the location and configuration of the inlet pipe 38 and introduction of the fluids near the outlet end 42 of the inlet pipe 38 near the upper end 16 of the vessel 12 may encourage the solids 90 to remain near the upper end 16 of the vessel 12 for removal via the solids spillway 58. The introduction of the bubbles 88 further promotes this process.

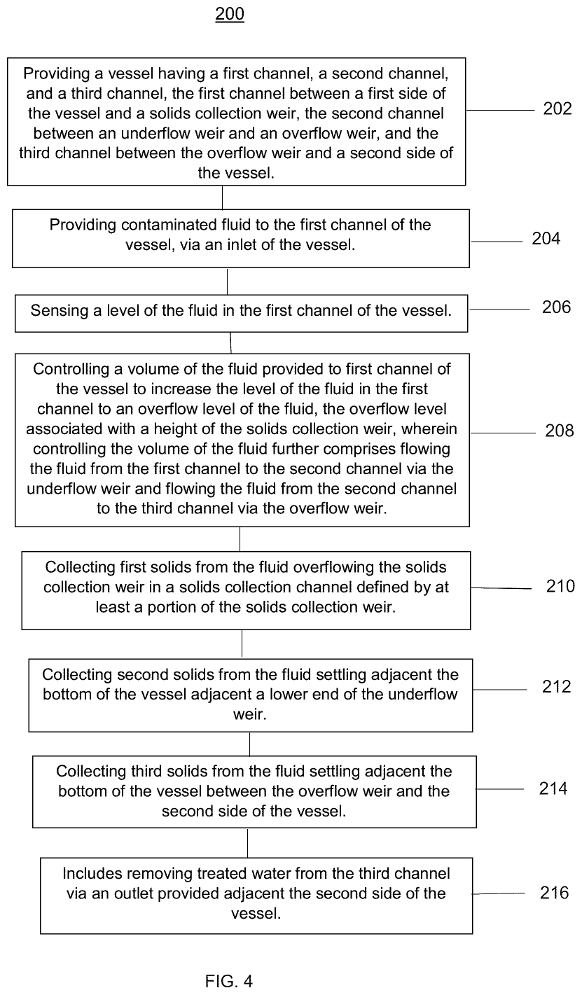

FIG. 4 is a flow chart illustrating a method 200 for solids removal according to one embodiment. The method 200, at block 202, includes providing a vessel having a first channel, a second channel, and a third channel, the first channel between a first side of the vessel and a solids collection weir, the second channel between an underflow weir and an overflow weir, and the third channel between the overflow weir and a second side of the vessel. The method 200, at block 204, includes providing contaminated fluid to the first channel of the vessel, via an inlet of the vessel, and at block 206, sensing a level of the fluid in the first channel of the vessel. The method 200, at block 208, includes controlling a volume of the fluid provided to first channel of the vessel to increase the level of the fluid in the first channel to an overflow level of the fluid, the overflow level associated with a height of the solids collection weir, wherein controlling the volume of the fluid further comprises flowing the fluid from the first channel to the second channel via the underflow weir and flowing the fluid from the second channel to the third channel via the overflow weir. The method 200, at block 210, includes collecting first solids from the fluid overflowing the solids collection weir in a solids collection channel defined by at least a portion of the solids collection weir, at block 212, collecting second solids from the fluid settling adjacent the bottom of the vessel adjacent a lower end of the underflow weir, and at block 214, collecting third solids from the fluid settling adjacent the bottom of the vessel between the overflow weir and the second side of the vessel. The method 200, at block 216, includes removing treated water from the third channel via an outlet provided adjacent the second side of the vessel.

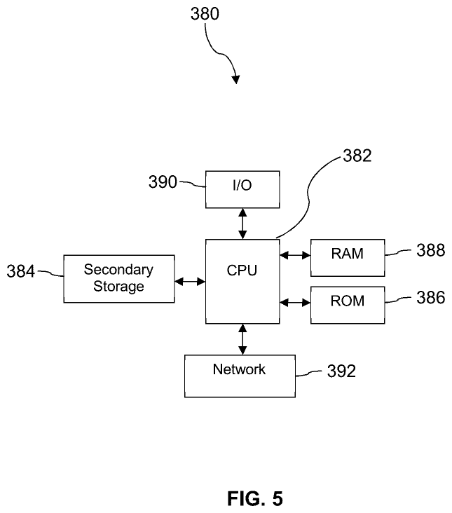

As discussed above, the solids removal system 10 and vessel 12 may include a computer and/or control system 111 coupled to monitor various sensors and systems and operate various valves to control the operation of the solids removal system 10 and vessel 12. The computer and/or control system 111 may be implemented as a computer program or tool on a computer system or accessible by computer system via a web interface. As discussed above, the control system 111 and the various subcomponents may be implemented as computer software applications or instructions executing on a computer system. FIG. 5 illustrates such a computer system 380 suitable for implementing one or more embodiments disclosed herein. The computer system 380 includes a processor 382 (which may be referred to as a central processor unit or CPU) that is in communication with memory devices including secondary storage 384, read only memory (ROM) 386, random access memory (RAM) 388, input/output (I/O) devices 390, and network connectivity devices 392. The processor 382 may be implemented as one or more CPU chips.

It is understood that by programming and/or loading executable instructions onto the computer system 380, at least one of the CPU 382, the RAM 388, and the ROM 386 are changed, transforming the computer system 380 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 380 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards, and/or other well-known network devices. The network connectivity devices 392 may provide wired communication links and/or wireless communication links (e.g., a first network connectivity device 392 may provide a wired communication link and a second network connectivity device 392 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In an embodiment, the radio transceiver cards may provide wireless communication links using protocols such as code division multiple access (CDMA), global system for mobile communications (GSM), long-term evolution (LTE), WiFi (IEEE 802.11), Bluetooth, Zigbee, narrowband Internet of things (NB IoT), near field communications (NFC), radio frequency identity (RFID), and/or the like. The radio transceiver cards may promote radio communications using 5G, 5G New Radio, or 5G LTE radio communication protocols. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk-based systems may all be considered secondary storage 384), flash drive, ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 380 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 380 to provide the functionality of a number of servers that is not directly bound to the number of computers in the computer system 380. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid-state memory chip, for example analog magnetic tape, compact disk read only memory (CD-ROM) disks, floppy disks, jump drives, digital cards, multimedia cards, and others. The computer program product may be suitable for loading, by the computer system 380, at least portions of the contents of the computer program product to the secondary storage 384, to the ROM 386, to the RAM 388, and/or to other non-volatile memory and volatile memory of the computer system 380. The processor 382 may process the executable instructions and/or data structures in part by directly accessing the computer program product, for example by reading from a CD-ROM disk inserted into a disk drive peripheral of the computer system 380. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 380.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer system 380 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A solids removal system, comprising:
a vessel including:
an upper end,
a lower end opposite the upper end,
an outer wall defining an interior space of the vessel and extending from the lower end to the upper end,
a bottom connected to the outer wall adjacent the lower end,
a bottom drain connected to the bottom,
an inlet coupled to the outer wall adjacent the lower end, and
an outlet coupled to the outer wall adjacent the lower end;
an underflow weir positioned in the interior space and connected to the vessel near the upper end of the vessel and extending a distance to a lower end of the underflow weir located adjacent the lower end of the vessel, the underflow weir located between the inlet and outlet;
a solids collection weir positioned in the interior space between the underflow weir and the inlet, the solids collection weir having an upper end and a lower end, the upper end of the solids collection weir located a distance from the upper end of the vessel, and the lower end located adjacent the lower end of the vessel;
a weir bottom having a first side and a second side, the weir bottom connected on the first side to the underflow weir and connected on the second side to the solids collection weir; and
an overflow weir positioned in the interior space and connected to the vessel adjacent the lower end of the vessel and extending a distance to an upper end of the overflow weir located adjacent the upper end of the vessel, the overflow weir located between the underflow weir and the outlet.

2. The solids removal system of claim 1, wherein the weir bottom is connected on the first side to the lower end of the underflow weir and wherein the weir bottom is connected on the second side to lower end of the solids collection weir.

3. The solids removal system of claim 1, wherein the vessel further comprises an inlet pipe connected to the inlet, the inlet pipe extending horizontally, relative to a vertical operational orientation of the vessel, a first distance into the interior space from the outer wall, the inlet pipe further extending vertically, relative to the vertical operational orientation of the vessel, a second distance in the interior space towards the upper end of the vessel, the inlet pipe having an outlet end opposite the inlet.

4. The solids removal system of claim 3, further comprising one or more bubblers coupled to the vessel adjacent the inlet pipe.

5. The solids removal system of claim 1, wherein the bottom is substantially conically shaped and defines a first discharge area, and wherein the bottom drain is connected to the bottom adjacent the first discharge area.

6. The solids removal system of claim 1, wherein the weir bottom includes a second discharge area, and wherein a second drain is coupled adjacent the second discharge area.

7. The solids removal system of claim 1, further comprising:
one or more contaminated liquid sources coupled to the inlet;
one or move removal tanks couple to one or more of the bottom drain or second drain;
a plurality of valves to regulate the flow of fluids or solids from the one or more contaminated liquid sources to the inlet and further regulate the flow of fluid or solids from the bottom drain and second drain to the one or more removal tanks;
one or more sensors coupled to the vessel adjacent the upper end of the vessel and configured to monitor a fluid or solids level in the interior space of the vessel; and
a control system in communication with the one or more sensors and operably coupled to actuate one or more of the plurality of valves in response to the fluid or solids level in the interior space of the vessel sensed by the sensors.

8. The solids removal system of claim 1, further comprising a plurality of vessels, each of the plurality of vessels in fluid communication with one or more contaminated liquid sources coupled at the inlets of each of the plurality of vessels and further in fluid communication with one or move removal tanks coupled to at least one of the bottom drains or second drains of each of the plurality of vessels.

9. The solids removal system of claim 1, further comprising a third drain coupled adjacent the bottom of the vessel between the underflow weir and outlet.

10. A method for solids removal, comprising:
providing a vessel having a first channel, a second channel, and a third channel, the first channel between a first side of the vessel and a solids collection weir, the second channel between an underflow weir and an overflow weir, the third channel between the overflow weir and a second side of the vessel;
providing contaminated fluid to the first channel of the vessel, via an inlet of the vessel;
sensing a level of the fluid in the first channel of the vessel;
controlling a volume of the fluid provided to first channel of the vessel to increase the level of the fluid in the first channel to an overflow level of the fluid, the overflow level associated with a height of the solids collection weir, wherein controlling the volume of the fluid further comprises flowing the fluid from the first channel to the second channel via the underflow weir and flowing the fluid from the second channel to the third channel via the overflow weir;
collecting first solids from the fluid overflowing the solids collection weir in a solids collection channel defined by at least a portion of the solids collection weir;
collecting second solids from the fluid settling adjacent the bottom of the vessel adjacent a lower end of the underflow weir;
collecting third solids from the fluid settling adjacent the bottom of the vessel between the overflow weir and the second side of the vessel; and
removing treated water from the third channel via an outlet provided adjacent the second side of the vessel.

11. The method of claim 10, wherein controlling the volume of fluid includes controlling, by a control system, at least one or more pumps or at least one or move valves coupled to provide the fluid to the first channel of the vessel.

12. The method of claim 10, wherein a weir bottom is connected on a first side to a lower end of the underflow weir and wherein the weir bottom is connected on a second side to a lower end of the solids collection weir, the solids collection channel further defined by the solids collection weir on a first side, the underflow weir on a second side and the weir bottom on a lower side.

13. The method of claim 10, wherein providing the contaminated fluid to the first channel of the vessel via an inlet further comprises:
providing an inlet pipe connected to the inlet, the inlet pipe extending horizontally, relative to a vertical operational orientation of the vessel, a first distance into the interior space from the outer wall, the inlet pipe further extending vertically, relative to the vertical operational orientation of the vessel, a second distance in the interior space towards the upper end of the vessel, the inlet pipe having an outlet end opposite the inlet; and
providing the contaminated fluid to the first channel via the inlet pipe.

14. The method of 10, further comprising introducing bubbles into the fluid in the first channel via one or more bubblers.

15. The method of claim 10, further comprising:
receiving the fluid from one or more contaminated liquid sources coupled to the inlet; and
transferring one or more of the first, second, or third solids to one or more removal tanks.

16. The method of claim 10, further comprising:
sensing that the level of the fluid in the first channel of the vessel exceeds a threshold level; and
actuating one or more valves or one or more pumps to reduce the flow of contaminated fluid into the first channel of the vessel.

17. The method of claim 10, further comprising:
providing the contaminated fluid to a plurality of vessels at the inlets of each of the plurality of vessels; and
removing fluids or solids from the plurality of vessels to one or move removal tanks.

18. The method of claim 10, further comprising venting one or more of gases or fluids from the vessel.

19. A solids removal system, comprising:
a vessel including:
an upper end,
a lower end opposite the upper end,
an outer wall defining an interior space of the vessel and extending from the lower end to the upper end,
a bottom connected to the outer wall adjacent the lower end,
a bottom drain connected to the bottom,
an inlet coupled to the outer wall adjacent the lower end, and
an outlet coupled to the outer wall adjacent the lower end;
an underflow weir positioned in the interior space and connected to the vessel near the upper end of the vessel and extending a distance to a lower end of the underflow weir located adjacent the lower end of the vessel, the underflow weir located between the inlet and outlet;
a solids collection weir positioned in the interior space between the underflow weir and the inlet, the solids collection weir having an upper end and a lower end, the upper end of the solids collection weir located a distance from the upper end of the vessel, and the lower end located adjacent the lower end of the vessel; and
a weir bottom having a first side and a second side, the weir bottom connected on the first side to the lower end of the underflow weir and wherein the weir bottom is connected on the second side to lower end of the solids collection weir.

20. The solids removal system of claim 19, further comprising an overflow weir positioned in the interior space and connected to the vessel adjacent the lower end of the vessel and extending a distance to an upper end of the overflow weir located adjacent the upper end of the vessel, the overflow weir located between the underflow weir and the outlet.
